(19) United States
(12) Patent Application Publication
(10) Pub. No.: US 2017/0161529 A1
(43) Pub. Date: Jun. 8, 2017

(54) OBJECT RECOGNITION ENCODER

(71) Applicant: Checkpoint Systems, Inc., Thorofare, NJ (US)

(72) Inventor: Petya Vachranukunkiet, Warrington, PA (US)

(21) Appl. No.: 14/958,503

(22) Filed: Dec. 3, 2015

(51) Int. Cl. G06K 7/10; G06K 9/62; G06K 7/14

(52) U.S. Cl. CPC G06K 7/10198; G06K 7/10554; G06K 7/1413; G06K 9/6232

(57) ABSTRACT

In one embodiment, the disclosure can be a method for associating data to an RFID tag, the method including obtaining an image associated with a product to which an RFID tag is to be attached; processing the image to determine a physical attribute of the product; generating a physical attribute identifier associated with the physical attribute; and writing a tag identifier to the RFID tag, the physical attribute identifier forming part of the tag identifier.

### BACKGROUND

Radio frequency identification (RFID) tags can be used to track items. During the RFID tag commissioning process, RFID tags are typically programmed with an EPC (Electronic Product Code) that includes a UPC (Universal Product Code) and a serial number, which may be a code of any format and not necessarily a number that is serial in nature. The UPC can be obtained from a bar code label associated with the product to be tagged, and can refer to a type of product. The serial number, on the other hand, provides a number unique to the specific product being tagged.

While an EPC programmed to an RFID tag provides helpful information about the product tagged, there is need for additional information to be efficiently associated with the EPC to enhance the utility of the RFID tag.

### BRIEF SUMMARY

The present disclosure is directed to a method and system for associating data to an RFID tag and identifying theft. In one aspect, the method includes obtaining an image associated with a product to which an RFID tag is to be attached; processing the image to determine a physical attribute of the product; generating a physical attribute identifier associated with the physical attribute; and writing a tag identifier to the RFID tag, the physical attribute identifier forming part of the tag identifier.

In another aspect, a system includes a camera configured to obtain an image associated with a product to which an RFID tag is to be attached; a processor configured to process the image to obtain a physical attribute of the product; and generate a physical attribute identifier associated with the physical attribute; and an RFID reader configured to write a tag identifier to the RFID tag, the physical attribute identifier forming part of the tag identifier.

In yet another aspect, a method includes determining a physical attribute of a product from light reflected by the product or by an item associated with the product; generating a physical attribute identifier associated with the physical attribute; and writing a tag identifier to the RFID tag, the tag identifier comprising the physical attribute identifier. The physical attribute of the product can be a color of the product, and a color sensor can process the light reflected by the product. Further, an image of the product can be obtained from light reflected by the product, and the physical attribute can be determined by processing the image of the product.

In yet another aspect, a method includes receiving a product presented for purchase at a point of sale (POS), an RFID tag being attached to the product; reading a tag identifier of the RFID tag at the POS; determining a physical attribute of the product from the tag identifier, the determination of the physical attribute not requiring reference to a database external to the POS; displaying, on a display at the POS, the physical attribute; and determining whether the physical attribute corresponds to the product presented for purchase.

### BRIEF DESCRIPTION OF THE DRAWINGS

The present disclosure will become more fully understood from the detailed description and the accompanying drawings, wherein:

FIG. 1 is a block diagram of a system according to one embodiment of the disclosure.

FIG. 2 is a tag identifier according to one embodiment of the disclosure.

FIG. 3 is a block diagram of an RFID tag according to one embodiment of the disclosure.

FIG. 4 is a block diagram of a system for obtaining an image of a tag according to another embodiment of the disclosure.

FIG. 5 is a block diagram of a system for obtaining an image of an informational tag according to another embodiment of the disclosure.

FIG. 6A is a flow chart of a method for associating data to an RFID tag according to one embodiment of the disclosure.

FIG. 6B is a block diagram of a system using a sensor according to another embodiment of the disclosure.

FIG. 7 is a block diagram of a system for identifying an attempted theft according to one embodiment of the disclosure.

FIG. 8 is a flow chart of a method for identifying an attempted theft according to one embodiment of the disclosure.

### DETAILED DESCRIPTION

The following description of the preferred embodiment(s) is merely exemplary in nature and is in no way intended to limit the disclosure. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present disclosure. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” “secured” and similar refer to a relationship wherein structures are secured or attached to one another either directly or indirectly through intervening structures, as well as both movable or rigid attachments or relationships, unless expressly described otherwise. The discussion herein describes and illustrates some possible non-limiting combinations of features that may exist alone or in other combinations of features. The discussion herein describes and illustrates some possible non-limiting combinations of features that may exist alone or in other combinations of features.

Features of the present disclosure may be implemented in software, hardware, firmware, or combinations thereof. The computer programs described herein are not limited to any particular embodiment, and may be implemented in an operating system, application program, foreground or background processes, driver, or any combination thereof. The computer programs may be executed on a single computer or server processor or multiple computer or server processors.

Processors described herein may be any central processing unit (CPU), microprocessor, micro-controller, computational, or programmable device or circuit configured for executing computer program instructions (e.g. code). Various processors may be embodied in computer and/or server hardware of any suitable type (e.g. desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi, Bluetooth, LAN, etc.

Computer-executable instructions or programs (e.g. software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs may be referred to as a “programmable device”, or “device”, and multiple programmable devices in mutual communication may be referred to as a “programmable system.” It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g. internal/external hard disks, floppy discs, magnetic tape CD-ROM, DVD-ROM, optical disk, ZIP™ drive, Blu-ray disk, and others), which may be written to and/or read by a processor operably connected to the medium.

In certain embodiments, the present disclosure may be embodied in the form of computer-implemented processes and apparatuses such as processor-based data processing and communication systems or computer systems for practicing those processes. The present disclosure may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

Generally, the disclosure includes a description of a system and method for determining a physical attribute of a product, generating a physical attribute identifier associated with the physical attribute, and writing a tag identifier to the RFID tag, the tag identifier comprising the physical attribute identifier. The disclosure further describes a system and method for identifying an attempted theft by determining whether a physical attribute determined at a point of sale (POS) corresponds with the product presented for purchase.

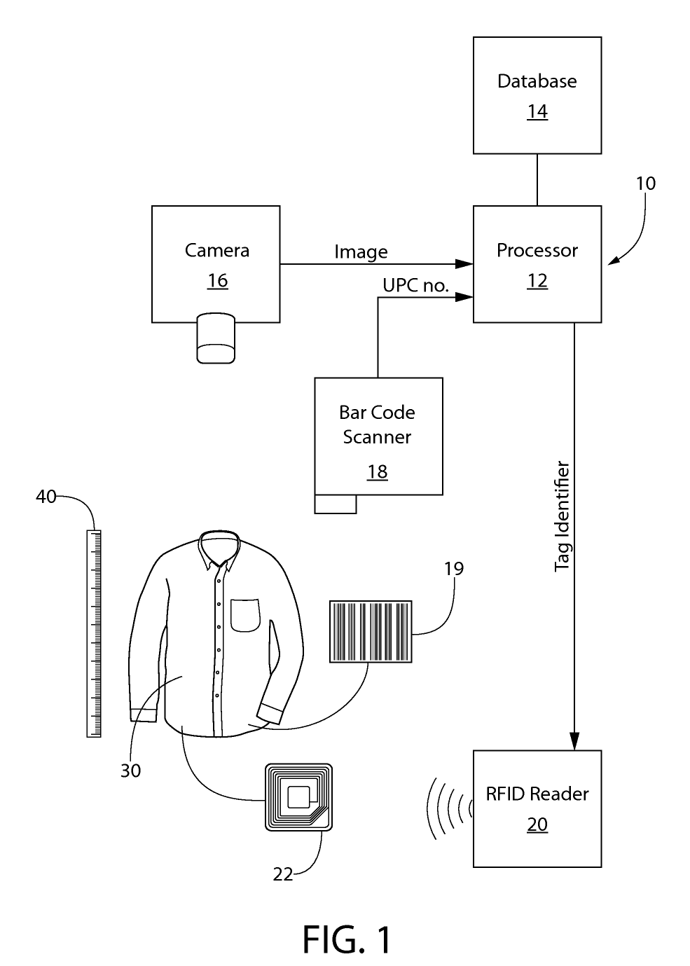

Referring now to FIG. 1, a block diagram of a system 10 according to one embodiment of the disclosure is shown. The system 10 includes a processor 12, a database 14, an RFID reader 20, a camera 16, and a bar code scanner 18. In this embodiment, the camera 16 can obtain an image of a product 30 and a reference object 40, and the bar code scanner 18 can obtain a UPC from a bar code 19 associated with the product 30. This data can be sent to the processor 12. The processor 12 can generate a tag identifier, such as an EPC, based on this data. The processor 12 can send the tag identifier to the RFID reader 20, and the RFID reader 20 can write the tag identifier to an RFID tag 22 attached to the product 30. The RFID reader 20 can be any device configured to write data to an RFID tag.

In the exemplified embodiment, the image is a photograph of the product 30 taken by the camera 16. The processor 12 can process the photograph using well-known image processing techniques to obtain a physical attribute of the product 30. Such processing can determine various characteristics of the image, such as size, shape, pattern, and color. The processor 12 can then reference a database 14 that associates a characteristic with a physical attribute identifier. The database 14 can be at any location, including local to the processor or at a remote location with which the database is in communication.

The disclosure is not limited to photographic images of the product 30. The image can be any representation of an external form, including a scan or video. In the case of video, video analytics can be used to process the image and determine a physical attribute of the product 30. Further, as will be discussed below, the image need not be of the product 30, but can also be of a tag or measuring device or other object associated with the product 30. In yet other embodiments, reflected light can be processed instead of an image (e.g., using an RGB color sensor). The camera can be any device for obtaining an image associated with a product.

In the exemplified embodiment, the physical attribute of the product 30 determined by the system 10 is the size of the product 30. The image of the product 30 taken by the camera 16 includes an image of a reference object 40 (e.g., a ruler) having a known size. The reference object 40 is located proximate to the product 30 can be any object of known size that can be included in the image of the product 30. The processor 12 can use the image of the reference object 40 included in the product image to determine the size of the product 30. In other embodiments, the reference object can be omitted.

For example, in one embodiment, the physical attribute of the product 30 determined by the system 10 can be the shape of the product 30. The processor 12 can use standard image processing techniques to determine the shape of the product 30. Such shapes can include circular, rectangular, square, shirt-shaped, pants-shaped, belt-shaped, and indeterminate.

In yet another embodiment, the physical attribute of the product 30 determined by the system 10 can be a pattern of the product 30. The processor 12 can use standard image processing techniques to determine the pattern of the product 30. Such patterns can include solid, striped, and plaid.

In yet another embodiment, the physical attribute of the product 30 determined by the system 10 can be a color of the product 30. The processor 12 can use standard image processing techniques to determine the color of the product 30 from the image. In other embodiments, discussed below, a color sensor can be used to determine a color from light reflected by the product 30. It is understood that the disclosure is not limited to determining the specific physical attributes identified above. Other physical attributes, or combinations of physical attributes, can be determined.

As shown in FIG. 1, a bar code scanner 18 scans a bar code 19 associated with the product 30. In so doing, the bar code scanner 18 (alone or in combination with a processor) can obtain a UPC associated with the product 30. Obtaining the UPC is part of the SGTIN-96 EPC scheme for commissioning an RFID tag. SGTIN (or Serialised Global Trade Item Number) combines a GTIN product identifier with a serial number unique to the specific item being tagged. The GTIN product identifier can include the UPC. In other embodiments, the tag identifier can omit a UPC, and the system 10 can exclude a bar code scanner.

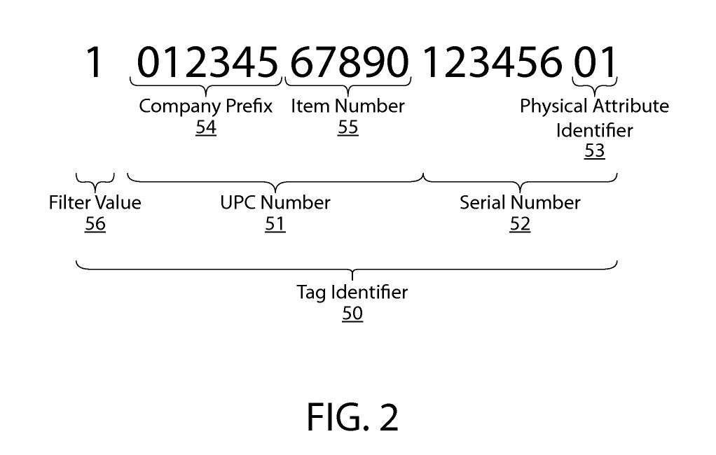

Referring now to FIG. 2, a tag identifier 50 for an RFID tag is shown. In this embodiment, the tag identifier 50 is an EPC according to the SGTIN-96 EPC scheme for commissioning an RFID tag. The EPC 50 includes a filter value 56, a UPC 51, and a serial number 52. The filter value 56 denotes the packaging level of the item. In the exemplified embodiment, the filter value 56 is “1” because the product 30 is a point of sale item.

The UPC 51 is the number obtained from the bar code 19 associated with the product 30. The UPC 51 can have two main components—a company prefix 54 and an item number 55. The company prefix 54 can denote the company that manufactured the product 30. The item number 55 can denote the specific type of item being sold.

The serial number 52 is specific to the single item being tagged. For example, the serial number 52 can distinguish a shirt from other shirts carrying the same UPC.

In the exemplified embodiment, the last two digits of the serial number 52 are used for the physical attribute identifier 53. In other embodiments, the physical attribute identifier can form any part of the tag identifier 50. In the exemplified embodiment, the physical attribute identifier 53 is “01,” indicating that the product 30 is of a size six to twelve inches in height. Other numbers, such as “02,” “03,” and “99,” can represent other sizes. As stated above, the physical attribute is not limited to size, but can be any observable or measurable physical attribute.

In typical EPCs, the physical attributes of a tagged item can only be determined by referring to an external database, such as database 14, which associates the EPC with different characteristics of the tagged product. In the exemplified embodiment, however, the physical attribute identifier 53 is a number that is fixed to represent the physical attribute and no other physical attribute. Thus, in this example, “01” represents six to twelve inches in height in all instances. As a result, when the RFID tag containing this EPC 50 is read, the reader 20 can determine the physical attribute “six to twelve inches in height” without reference to an external database. This information can therefore appear at a POS immediately, allowing a store clerk to confirm at the time of purchase that the product presented for sale corresponds with the information on the tag.

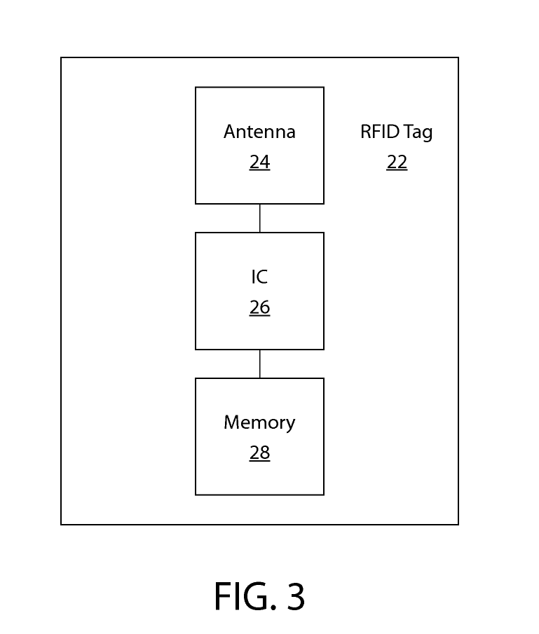

The system 10 can also store product-related information in memory on the tag. Referring now to FIG. 3, a block diagram of an RFID tag 22 according to one embodiment of the disclosure is shown. In addition to an antenna 24 and an integrated circuit (IC) 26, the RFID tag 22 can include a user memory 28. Product-related information can be stored in this user memory 28. Such information can include any information related to the product 30, including additional physical attributes (e.g., color or pattern), or a url link to more information about the tagged product 30. Further, the product-related information can include a data file, the data file including the image of the product 30 taken by the camera 16. Thus, data obtained when obtaining the physical attribute can be available directly from the tag. In yet other embodiments, product-related information can be stored in a database external to the tag 22, such as database 14. Note, however, that storage of such information on the tag is not necessary.

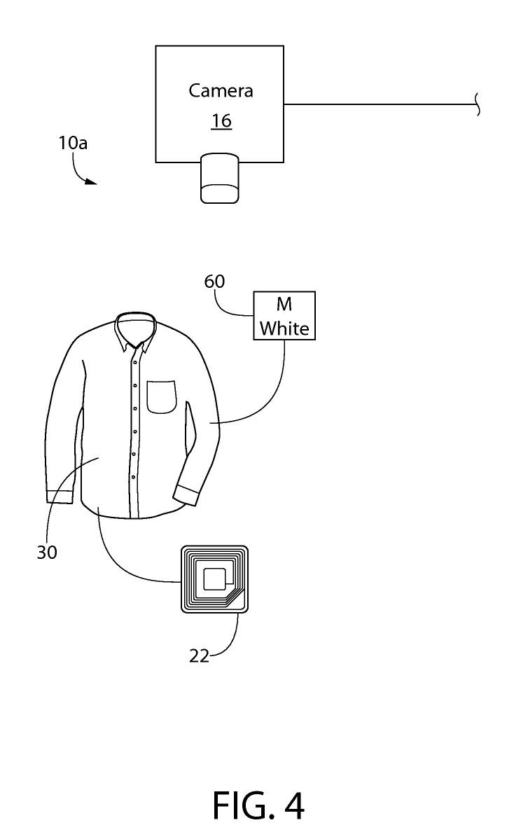

Referring now to FIG. 4, a block diagram of a system 10a for obtaining an image of a tag according to another embodiment of the disclosure is shown. This system 10a is similar to system 10, but camera 16 is directed not at the product 30, but at the informational tag 60. In the exemplified embodiment, the informational tag 60 has visible information printed thereon—namely, size information (“M” for medium) and color information (“White”).

The system 10a can operate similar to that described with respect to system 10, but the image associated with the product 30 is an image of an informational tag 60 associated with the product 30. Once the camera 16 obtains an image of the informational tag 60, the processor 12 can analyze that image to determine information printed on the tag 60. In the exemplified embodiment, the processor 12 uses optical character recognition (OCR) to obtain the physical attribute of the product 30 from the tag 60. By determining the text on the tag 60, the processor 12 can generate a physical attribute identifier 53 to form part of a tag identifier, and write that tag identifier to the RFID tag 22.

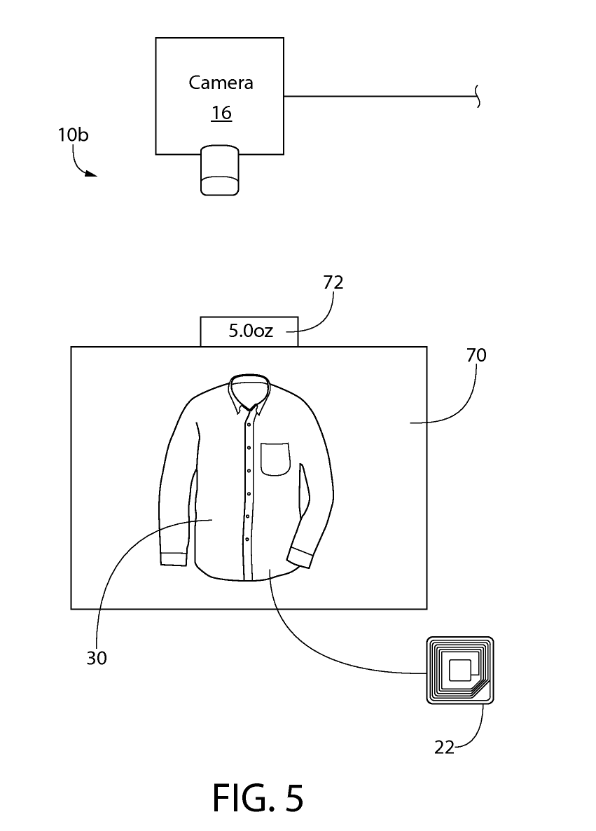

Referring now to FIG. 5, a block diagram of a system 10b for obtaining an image of a measuring device according to another embodiment of the disclosure is shown. This system 10b is similar to systems 10 and 10a, but the camera 16 is directed not at the product 30 or an informational tag, but at a measuring device 70. In the exemplified embodiment, the product 30 has been placed on the scale 70. The scale includes a digital display 72 that indicates the weight of the product 30. In other embodiments, the measuring device 70 can be any device for measuring a physical attribute of the product.

The system 10b can operate similar to that described with respect to system 10, but the image associated with the product 30 is an image of the measuring device 70 when the measuring device 70 is measuring the physical attribute of the product 30. In the exemplified embodiment, the camera 16 captures an image of the display 72 of the measuring device 70. The display shows the weight of the product. Once the camera 16 obtains an image of the display 72, the processor 12 can analyze that image to determine the weight of the product 30. In the exemplified embodiment, the processor 12 uses optical character recognition (OCR) to obtain the weight. By determining the weight, the processor 12 can generate a physical attribute identifier 53 to form part of a tag identifier, and write that tag identifier to the RFID tag 22. In other embodiments, other measuring devices can be used, and the image can be of a portion of the measuring device 70 that is not the display 72.

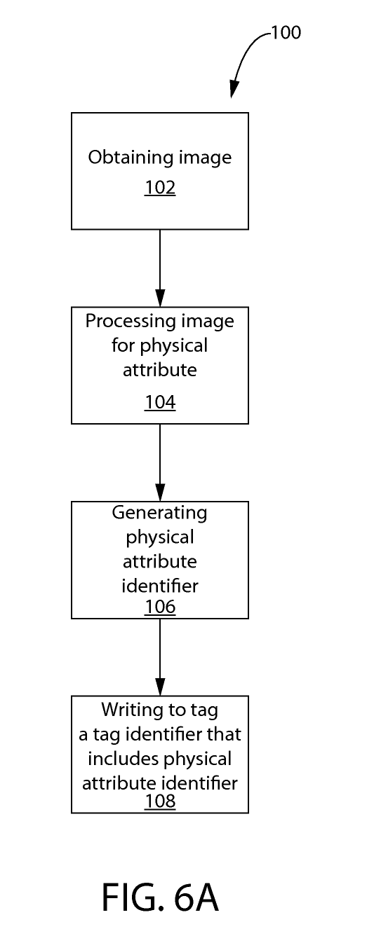

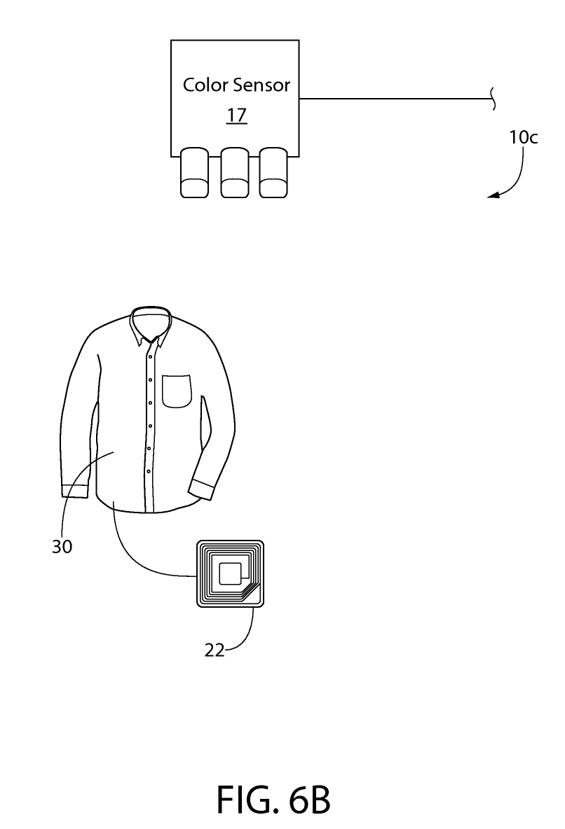

FIG. 6A is a flow chart showing a method of associating data to an RFID tag according to an embodiment of the disclosure. In this embodiment, the method includes obtaining an image associated with a product to which an RFID tag is to be attached (step 102); processing the image to determine a physical attribute of the product (step 104); generating a physical attribute identifier associated with the physical attribute (step 106); and writing a tag identifier to the RFID tag, the physical attribute identifier forming part of the tag identifier (step 108).

The disclosure is not so limited. In yet other embodiments, a method can include determining a physical attribute of a product from light reflected by the product or by an item associated with the product; generating a physical attribute identifier associated with the physical attribute; and writing a tag identifier to the RFID tag, the tag identifier comprising the physical attribute identifier. According to this embodiment, light reflected by the product can be used to determine a physical attribute. FIG. 6B shows a system 10c according to this method. An RGB color sensor 16 is used instead of a camera. The color sensor 16 directs light on the product and processes the light reflected back to determine the color of the product. In other embodiments, an image of the product can be obtained from the light reflected by the product.

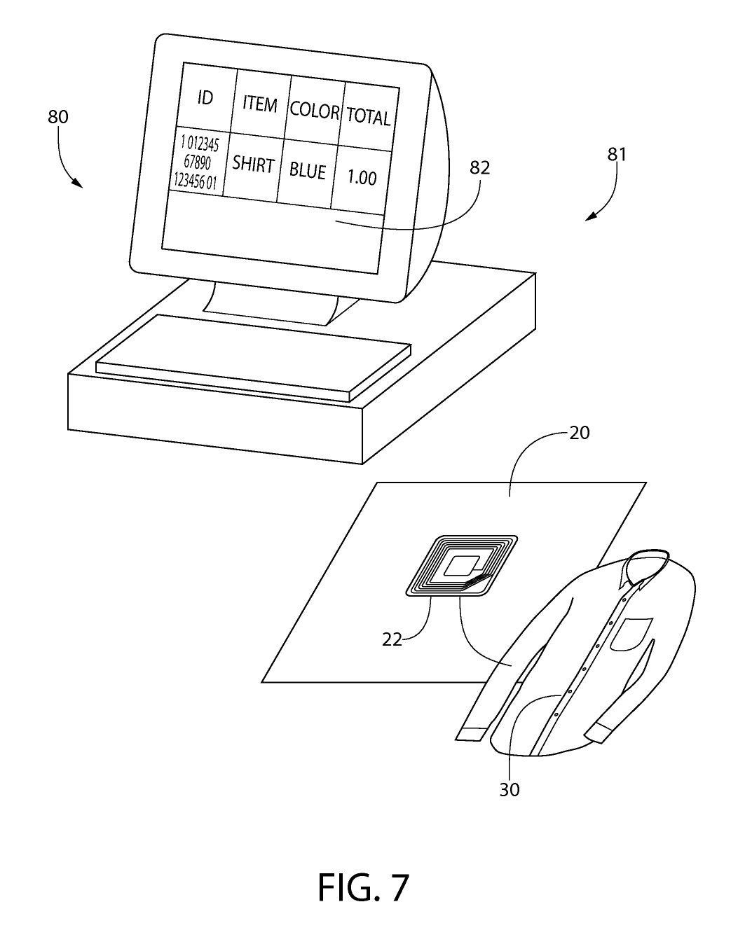

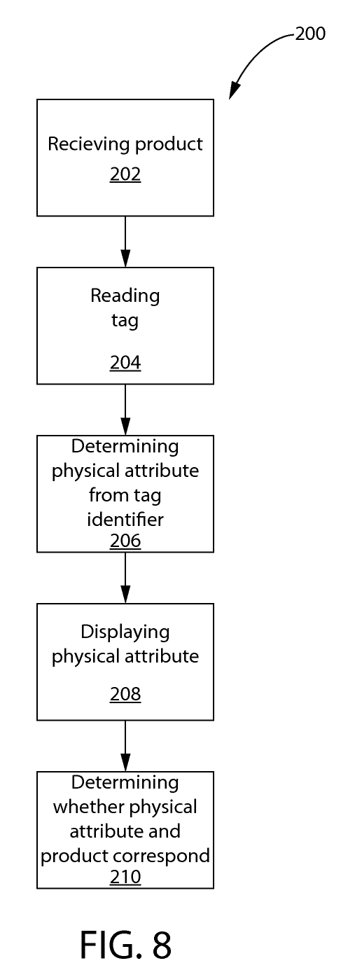

Referring now to FIGS. 7 and 8, a block diagram of a system 80 and a flow chart of a method 200 for identifying an attempted theft according to one embodiment of the disclosure is shown. In this system 80, the RFID tag 22 attached to the product 30 has received a tag identifier that includes physical attribute information. This information can be received by the tag 22 by the methods disclosed herein or by other methods. The system 80 and method are particularly well suited for identifying when a person has switched tags, trying to buy an expensive product using a tag for a lower-priced product.

In the exemplified method 200, a product 30 is presented for purchase at a POS 81 (step 202). The RFID tag 22 is attached to the product 30. The tag identifier (e.g., an EPC code) is read at the POS 81 (step 204). A physical attribute of the product 30 is determined from the tag identifier (step 206). The determination of the physical attribute does not require reference to a database physically external to the POS 81. In the exemplified embodiment, this is accomplished by using a tag identifier similar to the tag identifier with physical attribute identifier described above.

The display 82 at the POS 81 displays the physical attribute (step 208). Next, a determination can be made whether the physical attribute corresponds to the product 30 presented for purchase (step 210). In the exemplified embodiment, the product 30 is a white designer shirt. The RFID tag 22 of the product 30 is read by the RFID reader 20. The POS display 82 shows information regarding the purported item. In the exemplified embodiment, the display 82 shows an ID number (“10123456789012345601”), an item description (“shirt”), a color (“blue”), and a total price ($1.00). The information regarding the color (“blue”) was obtained from the physical attribute identifier “01” that forms part of the EPC. Because the physical attribute identifier forms part of the EPC, the physical attribute information (“blue”) is known immediately without reference to an external database. A store clerk can view the color information (“blue”), view the product 30 (a white shirt) and conclude that the RFID tag 22 attached to the product 30 is not proper. This is evidence that a thief tried to switch tags such that he would pay for the lower-priced blue shirt, rather than the designer white shirt.

The disclosure offers several advantages. As the most immediate embodiment explained, the disclosure can be used to prevent theft by identifying an improper tag for a product. Further, for purposes of commissioning, the described methods of obtaining physical attributes can be automated using image processing and/or sensors to speed commissioning and cause less human reliance and errors. The disclosed system and method can also provide immediate info to physical attribute information associated with the tag.

While the disclosure been described with respect to specific examples, those skilled in the art will appreciate that there are numerous variations and permutations of the above described disclosure. It is to be understood that other embodiments may be utilized and structural and functional modifications may be made without departing from the scope of the present disclosure. Thus, the spirit and scope should be construed broadly as set forth in the appended claims.

What is claimed is:

1. A method of associating data to an RFID tag, the method comprising:
obtaining an image associated with a product to which an RFID tag is to be attached;
processing the image to determine a physical attribute of the product;
generating a physical attribute identifier associated with the physical attribute; and
writing a tag identifier to the RFID tag, the physical attribute identifier forming part of the tag identifier.

2. The method of claim 1 wherein the image associated with the product is, or forms part of, a video.

3. The method of claim 1 wherein the image associated with the product is an image of the product.

4. The method of claim 3 wherein:
the physical attribute of the product is a size of the product; and
the image of the product includes an image of a reference object having a known size, the image of the reference object used in determining the physical attribute.

5. The method of claim 3 wherein the physical attribute of the product is a shape, pattern, or color of the product.

6. The method of claim 1 further comprising:
obtaining a UPC associated with the product; and
wherein the UPC forms part of the tag identifier.

7. The method of claim 6 wherein a serial number forms part of the tag identifier, the serial number being unique to the product, and the physical attribute identifier forms part of the serial number.

8. The method of claim 1 wherein the physical attribute identifier is a code that represents the physical attribute and no other physical attribute.

9. The method of claim 8 wherein the physical attribute identifier indicates the physical attribute without requiring reference to an external database.

10. The method of claim 1 further comprising storing product-related information in memory on the tag, wherein the product-related information includes a data file, the data file including the image of the product.

11. The method of claim 1 wherein the image associated with the product is an image of an informational tag associated with the product, the informational tag having visible information printed thereon.

12. The method of claim 11 wherein the processing of the image to obtain the physical attribute of the product includes using optical character recognition to obtain the physical attribute of the product from the tag.

13. The method of claim 1 wherein:
a measuring device measures the physical attribute of the product; and
the image associated with the product is an image of the measuring device when the measuring device is measuring the physical attribute of the product.

14. The method of claim 13 wherein the image of the measuring device is an image of a display of the measuring device, and the processing of the image uses optical character recognition.

15. The method of claim 14 wherein the physical attribute of the product is a weight of the product.

16. A system comprising:
a camera configured to obtain an image associated with a product to which an RFID tag is to be attached;
a processor configured to:
process the image to obtain a physical attribute of the product; and
generate a physical attribute identifier associated with the physical attribute; and
an RFID reader configured to write a tag identifier to the RFID tag, the physical attribute identifier forming part of the tag identifier.

17. The system of claim 16 further comprising:
a reference object located proximate to the product, the reference object having a known size;
wherein the image associated with the product is an image of the product;
wherein the physical attribute of the product is a size of the product; and
wherein the image associated with the product includes an image of the reference object.

18. The system of claim 16 further comprising:
a measuring device configured to measure a physical attribute of the product;
wherein the image associated with the product is an image of the measuring device when the measuring device is measuring the physical attribute of the product.

19. The system of claim 16 wherein the measuring device is a scale.

20. The system of claim 16 further comprising:
a bar code scanner configured to obtain a UPC from a bar code associated with the product;
wherein the UPC forms part of the tag identifier.

21. A method of identifying an attempted theft, the method comprising:
receiving a product presented for purchase at a point of sale (POS), an RFID tag being attached to the product;
reading a tag identifier of the RFID tag at the POS;
determining a physical attribute of the product from the tag identifier, the determination of the physical attribute not requiring reference to a database external to the POS;
displaying, on a display at the POS, the physical attribute; and
determining whether the physical attribute corresponds to the product presented for purchase.

22. The method of claim 21 wherein a physical attribute identifier forms part of the tag identifier, the physical attribute identifier being a number that is fixed to represent the physical attribute and no other physical attribute.

23. The method of claim 21 wherein the physical attribute is at least one of size, shape, pattern, color, and weight.

24. The method of claim 21 wherein the tag identifier is determined by:
obtaining an image associated with the product;
processing the image to determine the physical attribute of the product; and
generating a physical attribute identifier associated with the physical attribute, the physical attribute identifier forming part of the tag identifier.
